(19) United States
(12) Patent Application Publication
(10) Pub. No.: US 2013/0203369 A1
(43) Pub. Date: Aug. 8, 2013

(54) NOTCH FILTER INTEGRATED IN LNA OF A COEXISTING RADIO

(71) Applicants: Hakan Dogan, El Cerrito, CA (US); Lalitkumar Y. Nathawad, Fremont, CA (US)

(72) Inventors: Hakan Dogan, El Cerrito, CA (US); Lalitkumar Y. Nathawad, Fremont, CA (US)

(73) Assignee: QUALCOMM ATHEROS, INC., San Jose, CA (US)

(21) Appl. No.: 13/368,009

(22) Filed: Feb. 7, 2012

(51) Int. Cl. H04B 1/10

(52) U.S. Cl. 455/132

(57) ABSTRACT

A mechanism is disclosed for improving the performance of a coexisting radio by integrating a notch filter into an LNA of a first coexisting radio of two or more coexisting radios. The notch filter may be a differential circuit or a single-ended circuit. The single-ended circuit filters common mode signals. In one embodiment, the first coexisting radio has a carrier frequency that is in 2.4 GHz ISM frequency band and one of the other two or more coexisting radios has a carrier frequency that is in 1.9 GHz cellular band.

### BACKGROUND

The present specification describes an apparatus and method that generally relate to performance improvements in coexisting radios, and specifically to embodiments utilizing filters, such as notch filters, in a coexisting radio.

Multi-mode portable radio devices typically utilize designs that allow for simultaneous and independent operation of the devices. Often, multi-mode portable radio devices are integrated in a single handset or case. This environment presents a challenge since the typical multi-mode portable radio device may include at least one radio operating in the ISM band (e.g. Bluetooth or Wi-Fi), and a radio operating in a cellular band (e.g. a 3G or 4G cellular phone). These radios may be in close physical proximity as they are typically located in the same physical case. Hence, the multi-mode portable radios may be coexisting radios.

The cellular radio may transmit very high amounts of power in the 1.9 GHz frequency band which may cause the ISM band receivers operating at 2.4 GHz to saturate unless coexistence filtering is implemented. Some existing solutions may incorporate an on-board notch filter in the ISM band radio. This notch filter may be located between a low noise amplifier (LNA) and the mixer in the RF portion of the ISM band radio. This design adds additional cost and printed circuit board area to the radio design.

### SUMMARY

Various embodiments are disclosed of a circuit that improves the performance of a coexisting radio. In one embodiment, an apparatus comprising a notch filter integrated into an LNA of a first coexisting radio of two or more coexisting radios. The LNA inputs are coupled to an antenna and the LNA outputs are coupled to a mixer.

In one embodiment, the notch filter is integrated into the first coexisting radio which receives signals at lower signal strengths compared to at least one of the other two or more coexisting radios. The first coexisting radio has a carrier frequency that is in close proximity to a carrier frequency of one of the other two or more coexisting radios. The first coexisting radio has a carrier frequency and total bandwidth that is non-overlapping to carrier frequency and the total bandwidth of other coexisting radios.

In one embodiment, the first coexisting radio may have a carrier frequency that is in 2.4 GHz ISM frequency band and one of the other two or more coexisting radios may have a carrier frequency that is in 1.9 GHz cellular band. The first coexisting radio is in close physical proximity to one of the other two or more coexisting radios.

In one embodiment, the coexisting radios operate independently and may operate simultaneously. The notch filter may be a differential circuit or a single-ended circuit, wherein the single-ended circuit filters common mode signals. The notch filter may be implemented with capacitors, inductors and/or transformers.

### BRIEF DESCRIPTION OF THE DRAWINGS

The present embodiments may be better understood, and numerous objects, features, and advantages made apparent to those skilled in the art by referencing the accompanying drawings.

FIG. 1A illustrates an example apparatus having coexisting radios.

FIG. 1B illustrates an example of coexisting carrier frequencies in the apparatus.

FIG. 1C illustrates example block diagram of the front end components of a radio.

FIG. 2A illustrates an example LC circuit having a resonant frequency.

FIG. 2B illustrates the frequency response of notch circuit having a resonant frequency of 1.9 GHz.

FIG. 3 illustrates a notch filter integrated in an LNA, according to one embodiment.

FIG. 4A illustrates differential circuit embodiment of a notch filter.

FIG. 4B illustrates the operation of the differential circuit embodiment of a notch filter, per FIG. 4A.

FIG. 5A illustrates a single-ended circuit embodiment of a notch filter.

FIG. 5B illustrates the operation of the single-ended circuit embodiment of a notch filter, per FIG. 5A.

The components in the figures are not necessarily to scale, emphasis instead being placed upon illustrating the principles of the present embodiments. In the figures, like reference numerals designate corresponding parts throughout the different views.

### DESCRIPTION OF EMBODIMENT(S)

The present specification offers a low-cost and simple method to implement a notch filter in an apparatus comprising two or more coexisting radios. The notch filter is implemented with LC circuits that are integrated into at least one of the coexisting radios. The LC circuits comprise capacitors, inductors and/or transformers.

Definitions

Coexisting radios—Radios may be coexisting if their respective spectrums are in close proximity to one another such that one radio may be unable to operate due to interference from the other. The level of interference may increase when the coexisting radios are in close physical proximity to one another as is the case when coexisting radios are integrated in a handset. In other words, close physical proximity may mean that the coexisting radios are integrated into a single handset. Coexisting radios can operate independently. Hence, coexisting radios may receive signals simultaneously. Also, one of the coexisting radios may receive signals at the same time as the other coexisting radio transmits signals.

Notch filter is a notch filter that may be designed into one of the coexisting radios. For example, in systems with two coexisting radios, the notch filter can be integrated into the LNA of the coexisting radio that receives signals at lower signal strengths compared to the other coexisting radio. The notch filter can mitigate the interference from the stronger carrier of the other coexisting radio. For simultaneous reception on the first radio and transmission by the second radio, the receiver of the first radio may implement the notch filter to reduce the interference from the signals at higher signal strengths from the second radio. For simultaneous reception at the two radios, the signals received by the second radio may be associated with a higher signal strength compared to the signals received by the first radio. Therefore, the notch filter may be implemented in the first radio to help reduce the interference in the receiver of the first radio that receives weaker signals from the strong signals received by the receiver of the second radio.

Improved Performance—The performance may be improved in a coexisting radio if two or more coexisting radios successfully operate simultaneously (e.g., simultaneously receive signals), and/or the increase in component cost and PCB area is minimal.

Consider the situation with a handset having radios that support cellular and Wi-Fi services. The radio receives signals with a 1.9 GHz spectrum (e.g. cellular) and with a 2.4 GHz spectrum (e.g. Wi-Fi or Bluetooth operating in the ISM band). One cellular band in the US may be approximately 1700 MHz to 2100 MHz. At an antenna, the 1.9 GHz cellular spectrum may have significantly larger signal strength than the 2.4 GHz ISM band spectrum. The coexisting radio operating in the 2.4 GHz spectrum may have RF filtering intended to reduce the impact of the 1.9 GHz spectrum.

In operation, the cellular handset may begin transmitting (talking) in the 1.9 GHz spectrum. During this time period, if the Wi-Fi or Bluetooth radio attempts to connect while the cellular antenna is transmitting, the large 1.9 GHZ cellular signal may jam or otherwise interfere with the Wi-Fi or Bluetooth signal. The performance of the LNA and mixer related to a Wi-Fi or Bluetooth receiver may be degraded by the 1.9 GHz signal since it is in close proximity to the 2.4 GHz signal. Amplification of the Wi-Fi or Bluetooth signal may result in saturation in an Analog-to-Digital Converter (ADC).

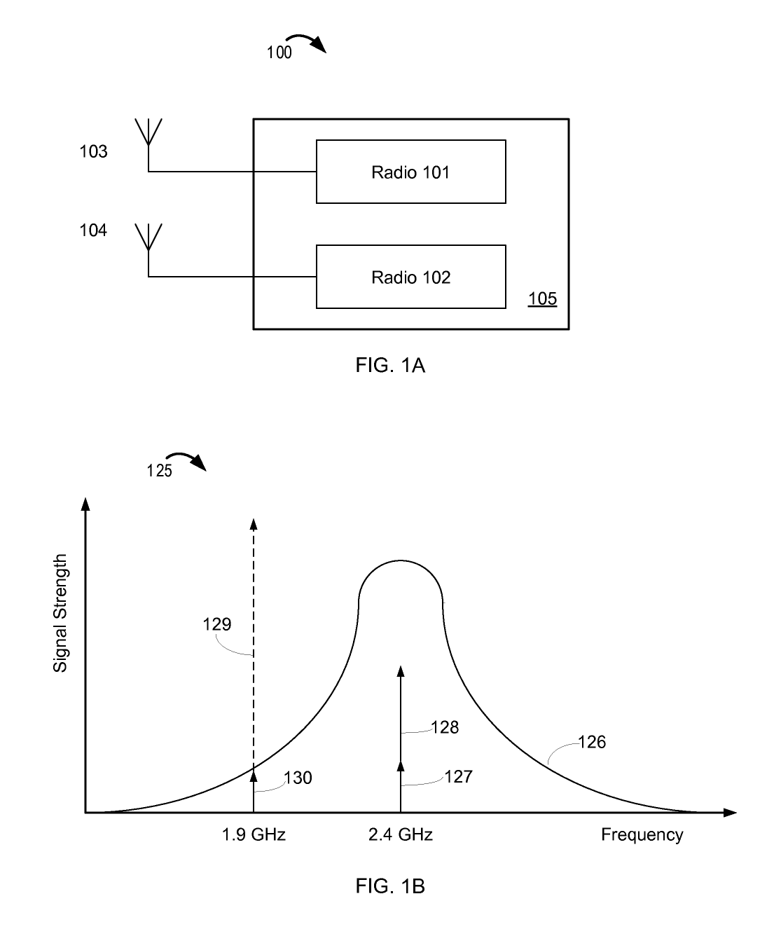

FIG. 1A illustrates an example apparatus having coexisting radios. Radio 101 and radio 102 are integrated into a single electronic device 105, In some embodiments, the electronic device 105 may be a mobile phone, a notebook computer, a tablet computer, a gaming console, a camera, a desktop computer, a smart appliance, or other suitable electronic communication devices with wireless communication capabilities, As shown, embodiment 100 includes two independent coexisting radios, radio 101, supported by antenna 103, and radio 102, supported by antenna 104. For example, radio 101 may be a radio operating in the 1.9 GHz cellular band and radio 102 may be a Wi-Fi or Bluetooth radio operating in the 2.4 GHz ISM band. The frequency spectrum is illustrated in FIG. 1B. The proximity of the two carrier frequencies and the close physical proximity of radio 101 and radio 102 enhance the potential interference issues between the coexisting radios.

The two coexisting radios may be such that the carrier frequencies are different and that the bandwidth required by the two radio systems does not overlap. As an illustration, assume the 2.4 GHz system has a carrier at 2.4 GHz and requires 40 MHZ of bandwidth, while a 2.1 GHz system has a carrier at 2.1 GHz and requires a channel bandwidth of 1.23 MHz wide. For this example, the spectrums would not overlap since the variations are 2.4 GHz−0.02 GHz and 2.1 GHz+0.000615 GHz.

FIG. 1B shows an example of coexisting carrier frequencies for radio 101 and radio 102. Per embodiment 125 of FIG. 1B, the carrier for radio 101 (e.g. a cellular radio) is represented by carrier 129 and the carrier for radio 102 (e.g. ISM band radio) is represented by carrier 127. Carrier 129 (cellular radio) of radio 101 may have a much higher signal strength than carrier 127 (ISM band radio) of radio 102.

In order to insure the performance of radio 102 (the ISM band radio), carrier 129 may be filtered by notch filter spectrum 126. Accordingly, the signal strength of carrier 129 may be reduced, as illustrated by carrier 130, On the other hand, carrier 127 may not be reduced by the notch filter, and may be amplified, as illustrated by carrier 128. Hence, after the notch filtering and amplification, carrier 127 (ISM radio) may have significantly higher signal strength as compared with carrier 130 (cellular radio). This result may allow radio 102 in the ISM band to successfully operate.

FIG. 1C illustrates an example block diagram of the RE portion of a radio such as radio 101 and radio 102. As shown in embodiment 150, the blocks may include antenna 151, RF 152 (e.g., one or more RF filters), LNA 153, mixer 154, filter 155, and ADC 156. In some embodiments, a notch filter may be integrated within the LNA 153, as will be further described below.

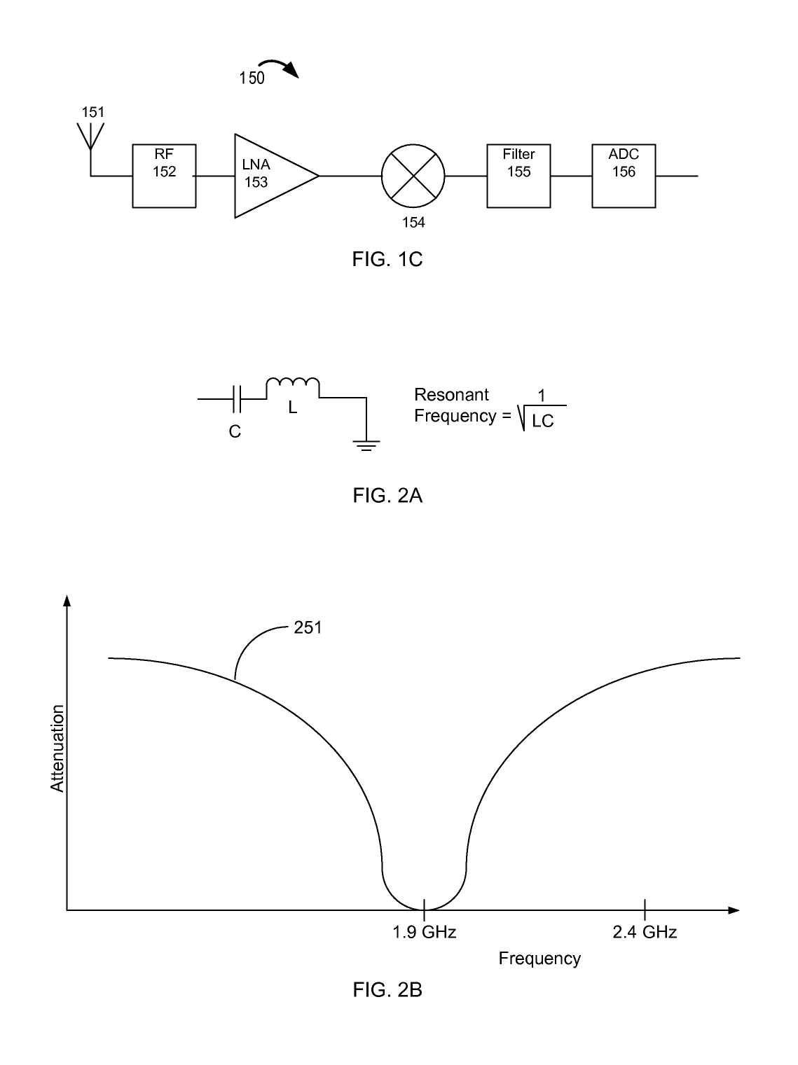

Notch filter spectrum 126 may be designed based on the characteristics of an circuit. An LC circuit, as illustrated in FIG. 2A, has resonant frequency of

$${\sqrt{LC}}^{1} .$$

It is noted, however, that in some implementations using the principles of circuit design, one skilled in the art may design a filter with the characteristics of notch filter spectrum 251 of FIG. 2B. As shown, notch filter spectrum 251 has a band pass centered at approximately 1.9 GHz. FIG. 2B may also illustrate a notch filter spectrum 251 may significantly attenuate any signal at 2.4 GHz. Hence, a notch filter with the characteristic of notch filter spectrum 251 may be useful to trap and filter out the high magnitude 1.9 GHZ cellular signals.

An apparatus for improving performance of a coexisting radio will now be described. The apparatus may comprise a notch filter integrated into an LNA of a first coexisting radio, wherein there are two or more coexisting radios. The notch filter may be integrated into the first coexisting radio which may be associated with weaker signals (e.g., receive signals at lower signal strengths) compared to one of the other two or more coexisting radios. The first coexisting radio has a carrier frequency that is in close proximity to carrier frequency of one of other two or more coexisting radios. The first coexisting radio may have a carrier frequency and total bandwidth that is non-overlapping with respect to carrier frequency and total bandwidth of the other coexisting radios.

The first coexisting radio may have a carrier frequency that is in 2.4 GHz ISM frequency band and one of the two or more coexisting radios may have a carrier frequency that is in 1.9 GHz cellular band. The first coexisting radio may be in close physical proximity to one of other two or more radios. An example of close physical proximity is the embodiment 100 where the two radios are located in the same electronic device (e.g., mobile phone). Additionally, the coexisting radios may operate independently.

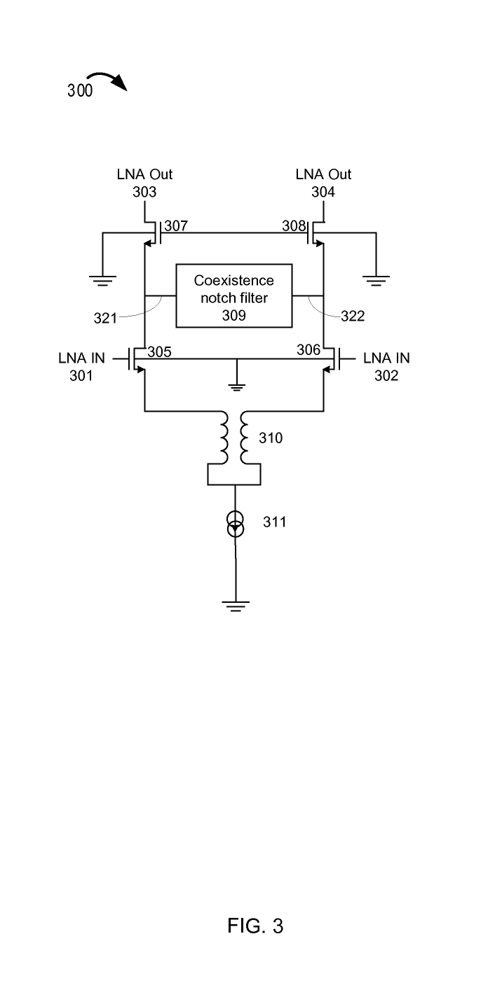

FIG. 3 illustrates notch filter 309 integrated in an LNA, according to one embodiment. As shown in embodiment 300, the input to embodiment 300 is coupled to LNA IN 301 and LNA IN 302. The output of embodiment 300 is coupled to LNA Out 303 and LNA Out 304. Per embodiment 300, the notch filter 309 is integrated between the LNA inputs and cascode devices at the cascode node.

In all, embodiment 300 comprises LNA IN 301 coupled to gate of FET 305, and LNA IN 302 coupled to gate of FET 306. The drain of the FET 305 is coupled to port 321 of the notch filter 309 and coupled to a source of FET 307; and the drain of FET 306 coupled to port 322 of the notch filter 309 and coupled to a source of FET 308.

The gate of FET 307 is coupled to the gate of FET 308; a drain of FET 307 is coupled to LNA OUT 303; and a drain of FET 308 is coupled to LNA OUT 304. A source of FET 305 is coupled to a first port on primary side of transformer 310 and a source of FET 306 is coupled to a first port on secondary side of transformer 310. The second port on the primary side of transformer 310 is coupled to a second port on the secondary side of transformer 310 and coupled to an input of an independent current source 311. An output of the independent current source 311 coupled to ground; and the substrates of FET 305, FET 306, FET 307 and FET 308 are coupled to ground. In this implementation, FET 305, FET 306, FET 307 and FET 308 are NMOS FETs.

Two types of notch filters are described in the present specification: (1) a differential notch circuit and (2) a single ended notch circuit.

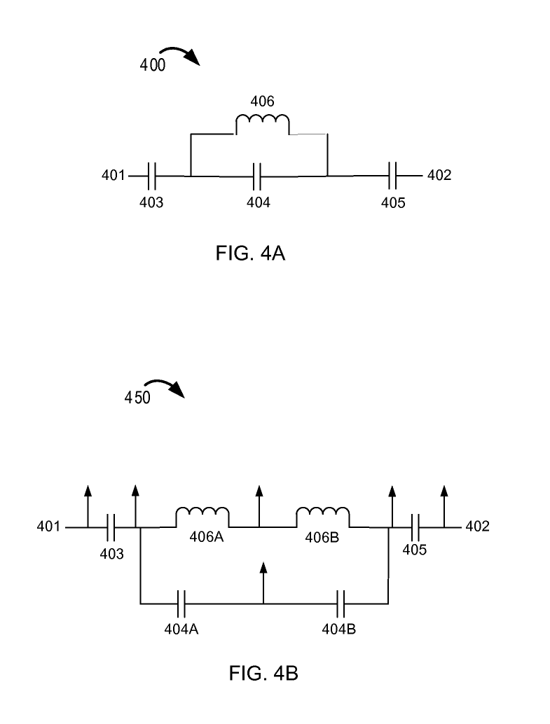

FIG. 4A illustrates a differential circuit, embodiment 400, of a notch filter. The filter consists of two series capacitors, capacitor 403 and capacitor 405, inductor 406 and one capacitor 404 located in parallel to inductor 406. The series capacitors, capacitor 403 and capacitor 405, may be tuned with inductor 406 at the notch frequency (e.g., around 1.85 GHz for the cellular band) to form a LC short at this frequency. The parallel capacitor, capacitor 404, is used to tune the structure to peak its impedance at the input signal frequency in order to minimize the loss of the desired signal. This way, while the unwanted blocker signal is attenuated with the notch filter, the desired signal is untouched or has minimal loss due to the added filter.

The filter may be implemented at the cascode node to minimize the loss of the desired signal, and to minimize the effect to an input impedance matching network. Since the cascode node is initially low impedance, as long as the filter impedance peaks to a relatively larger impedance at the desired frequency range, the loss of the desired signal is small. This configuration may limit the amount of filtering for the unwanted blocker signal. However, minimizing the in-band loss while rejecting the blocker may be a priority. In one embodiment, implementing the filter at the cascode node may provide attenuation with minimized in-band loss. This implementation may also minimize the effect on the input impedance matching since the load of the cascode node to the input is minimal, so any changes in the cascode impedance may have a minimal effect on the input impedance. If the signal coupled to the LNA inputs lacks common mode signal components, then the 1.9 GHz signal may be filtered from the desired signal.

The differential notch filter may include port 401 of the notch filter coupled to a first port of capacitor 403; a second port of capacitor 403 is coupled to a first port of inductor 406 and coupled to a first port of capacitor 404; the port 402 of the notch filter is coupled to a first port of capacitor 405; the second port of capacitor 405 is coupled to a second port of inductor 406 and coupled to a second port of capacitor 404; and wherein the notch filter is a differential circuit.

The differential notch filter may not be suitable for common mode signals. FIG. 4B illustrates the signal strength at each of the nodes in the differential notch filter when a common mode signal is coupled to port 401 and port 402. For common mode signals, the voltages for both cascade nodes (e.g. port 401 and port 402) are roughly equivalent as indicated by the arrows. In this case, the differential notch filter may not filter the 1.9 GHz signal and may couple the 1.9 GHz signal to the LNA output. Per embodiment 450, the signal at 1.9 GHz is coupled proportionately through each side of the filter circuit; hence the differential circuit operation. in this case, all modes track and the 1.9 GHz signal is coupled to the LNA outputs. in embodiment 450, inductor 406A and inductor 406B may each be one-half the value of inductor 406, and capacitors 404A and 404B may each be two times (twice) the value of capacitor 404.

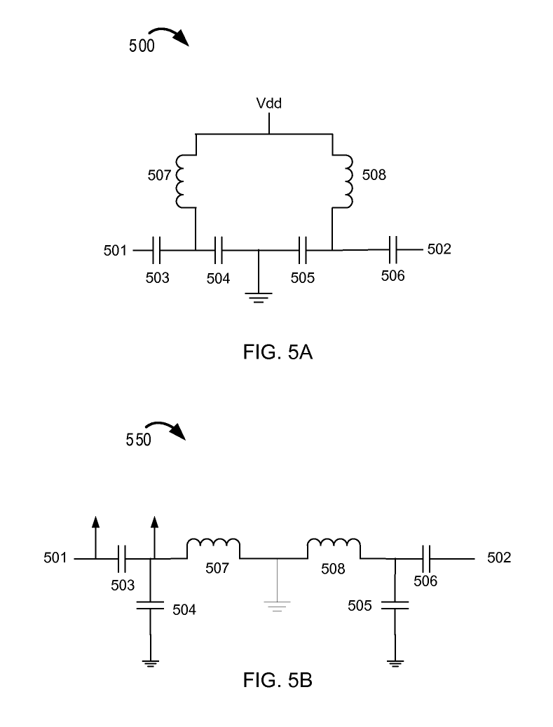

If the signal presented to the LNA inputs has common mode components, then a single-ended notch filter may be considered. FIG. 5A illustrates a single-ended circuit, embodiment 500, of a notch filter. FIG. 5A shows the same filter implementation in a single-ended manner. The filter in FIG. 4A acts as a notch filter for the differential inputs but it may not reject common mode signals.

It is probable that a narrow band balun, located after the antenna, may convert the desired signal to differential, and may pass the other bands, such as the cellular band, as common mode signals. In this case, a notch filter implementation as in FIG. 5A may reject the common mode signals as well and prevent the subsequent blocks from saturating.

FIG. 5B illustrates the operation of the single-ended circuit embodiment of a notch filter, per FIG. 5A. The arrows indicate the signal strength when a common mode signal is coupled to port 501 and port 502. As illustrated in embodiment 550, the 1.9 GHz signal is filtered or trapped on one side of the single-ended notch filter.

The single-ended notch filter comprising port 501 of the notch filter coupled to a first port of capacitor 503; a second port of capacitor 503 coupled to a first port of inductor 507 and coupled to a first port of capacitor 504; the port 502 of the notch filter coupled to a first port of capacitor 506; second port of capacitor 506 coupled to a first port of inductor 508 and coupled to a second port of capacitor 505; the first port of capacitor 505 and the second port of capacitor 504 are coupled to ground; and a second port of inductor 507 and the second port of inductor 508 are coupled to Vdd, wherein the notch filter is a single ended circuit.

The embodiments described in FIGS. 3, 4A and 5A may provide a low cost and simple way of achieving a notch filter to reject the strong blockers such as the cellular signals while causing minimal degradation at the desired frequency band (ISM). The differential notch filter described in FIG. 4A is more area efficient than the single-ended notch filter described in FIG. 5A. The differential notch filter may not be suitable for common mode signal.

A method is described for improving the performance of a coexisting radio comprising designing the notch filter with a combination of capacitors, inductors and/or transformers; integrating a notch filter in an LNA of a first coexisting radio, wherein there are two or more coexisting radios; coupling a signal from antenna to LNA inputs; and coupling a signal from LNA outputs to a mixer.

The notch filter may be a differential circuit or a single-ended circuit. The single-ended circuit filters common mode signals. The first coexisting radio has a carrier frequency that is in 2.4 GHz ISM frequency band and one of the two or more coexisting radios has a carrier frequency that is in 1.9 GHz cellular band. The notch filter is integrated into the first coexisting radio which may be associated with weaker signals (e.g., receive signals at lower signal strengths) compared to one of the other two or more coexisting radios.

Hence, it may be desirable to integrate a notch filter in the LNA, as described in the present specification, in order to achieve simultaneous operation of the coexisting radios and to reduce the cost and the circuit board area for implementing a notch filter.

It should be understood that FIGS. 1A-5B are examples meant to aid in understanding embodiments and should not be used to limit embodiments or limit scope of the claims. Embodiments may comprise additional circuit components, different circuit components, may perform additional operations, fewer operations, operations in a different order, operations in parallel, and some operations differently. In the examples described above for embodiment 100, a notch filter per the present specification was incorporated into radio 102. In general, the notch filter may be incorporated into either radio 101 or radio 102, or may be incorporated into both of the radios. In some examples, NMOS FETs are depicted within the circuits (e.g., FIG. 3); however, it is noted that in other implementations one or more of the FETs may be PMOS FETs.

While the embodiments are described with reference to various implementations and exploitations, it will be understood that these embodiments are illustrative and that the scope of the inventive subject matter is not limited to them. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. An apparatus for improving performance of a coexisting radio, the apparatus comprising a notch filter integrated into a low noise amplifier (LNA) of a first coexisting radio of two or more coexisting radios.

2. The apparatus as in claim 1, wherein the notch filter is integrated into the first coexisting radio which receives signals at lower signal strengths compared to at least one of other two or more coexisting radios.

3. The apparatus as in claim 1, wherein the first coexisting radio has a carrier frequency that is in close proximity to a carrier frequency of at least one of other two or more coexisting radios, wherein the first coexisting radio has the carrier frequency and a total bandwidth that is non-overlapping to a carrier frequency and a total bandwidth of each of the other two or more coexisting radios.

4. The apparatus as in claim 3, wherein the carrier frequency associated with the first coexisting radio is in 2.4 GHz ISM frequency band and the carrier frequency of the at least one of the other two or more coexisting radios is in 1.9 GHz cellular band.

5. The apparatus as in claim 1, wherein the first coexisting radio is in close physical proximity to the at least one of the two or more coexisting radios.

6. The apparatus as in claim 1, wherein the two or more coexisting radios operate independently.

7. The apparatus as in claim 1, wherein the notch filter is a differential circuit.

8. The apparatus as in claim 1, wherein the notch filter is a single-ended circuit that filters common mode signals.

9. The apparatus as in claim 1, wherein LNA inputs are coupled to an antenna and LNA outputs are coupled to a mixer.

10. The apparatus as in claim 1, wherein the LNA comprising the integrated notch filter further comprises:
a first LNA input coupled to a gate of a first FET;
a second LNA input coupled to a gate of a second FET;
a drain of the first FET coupled to a first port of the integrated notch filter and coupled to a source of a third FET;
a drain of the second FET coupled to a second port of the integrated notch filter and coupled to a source of a fourth FET;
a gate of the third FET coupled to a gate of the fourth FET;
a drain of the third FET coupled to a first LNA output;
a drain of the fourth FET coupled to a second LNA output;
a source of the first FET coupled to a first port on primary side of a first transformer and a source of the second FET coupled to a first port on secondary side of the first transformer;
a second port on the primary side of the first transformer coupled to a second port on the secondary side of the first transformer and to an input of an independent current source; and
an output of the independent current source coupled to ground.

11. The apparatus as in claim 10, wherein substrates of the first FET, second FET, third FET and fourth FET are coupled to ground, and wherein the first FET, second FET, third FET and fourth FET are NMOS FETs.

12. The apparatus as in claim 10, wherein the integrated notch filter comprises:
a first port of a first capacitor coupled to the first port of the integrated notch filter;
a first port of a second capacitor coupled to the second port of the integrated notch filter;
a second port of the first capacitor coupled to a first port of a first inductor and coupled to a first port of a third capacitor; and
a second port of the second capacitor coupled to a second port of the first inductor and coupled to a second port of the third capacitor,
wherein the integrated notch filter is a differential circuit.

13. The apparatus as in claim 10, wherein the integrated notch filter comprises:
a first port of a first capacitor coupled to the first port of the notch filter;
a first port of a second capacitor coupled to the second port of the integrated notch filter;
a second port of the first capacitor coupled to a first port of a second inductor and coupled to a first port of a third capacitor;
a second port of the second capacitor coupled to a first port of a third inductor and coupled to a first port of fourth capacitor;
a second port of the fourth capacitor and a second port of the third capacitor coupled to ground; and
a second port of the second inductor and a second port of the third inductor are coupled to supply voltage Vdd,
wherein the integrated notch filter is a single ended circuit.

14. A communication device comprising two or more coexisting radios, at least a first coexisting radio of the two or more coexisting radios of the communication device comprising:
an antenna; and
a low noise amplifier (LNA) with an integrated notch filter coupled with the antenna, the LNA with the integrated notch filter comprising:
a first LNA input coupled to a gate of a first FET;
a second LNA input coupled to a gate of a second FET;
a drain of the first FET coupled to a first port of the integrated notch filter and coupled to a source of a third FET;
a drain of the second FET coupled to a second port of the integrated notch filter and coupled to a source of a fourth FET;
a gate of the third FET coupled to a gate of the fourth FET;
a drain of the third FET coupled to a first LNA output; and
a drain of the fourth FET coupled to a second LNA output.

15. The communication device as in claim 14, wherein the LNA with the integrated notch filter further comprises:
a source of the first FET coupled to a first port on primary side of a first transformer and a source of the second FET coupled to a first port on secondary side of the first transformer;
a second port on the primary side of the first transformer coupled to a second port on the secondary side of the first transformer and to an input of an independent current source; and
an output of the independent current source coupled to ground.

16. The communication device as in claim 14, wherein the integrated notch filter comprises:
a first port of a first capacitor coupled to the first port of the integrated notch filter;
a first port of a second capacitor coupled to the second port of the integrated notch filter;
a second port of the first capacitor coupled to a first port of a first inductor and coupled to a first port of a third capacitor; and
a second port of the second capacitor coupled to a second port of the first inductor and coupled to a second port of the third capacitor,
wherein the integrated notch filter is a differential circuit.

17. The communication device as in claim 14, wherein the integrated notch filter comprises:
a first port of a first capacitor coupled to the first port of the notch filter;
a first port of a second capacitor coupled to the second port of the integrated notch filter;
a second port of the first capacitor coupled to a first port of a second inductor and coupled to a first port of a third capacitor;
a second port of the second capacitor coupled to a first port of a third inductor and coupled to a first port of fourth capacitor;
a second port of the fourth capacitor and a second port of the third capacitor coupled to ground; and
a second port of the second inductor and a second port of the third inductor are coupled to supply voltage Vdd,
wherein the integrated notch filter is a single ended circuit.

18. The communication device as in claim 14, wherein the first and second LNA outputs are coupled with a mixer of the first coexisting radio.

19. The communication device as in claim 18, wherein the first and second LNA inputs are coupled with an output of the antenna.

20. The communication device as in claim 18, further comprising RF filters of the first coexisting radio coupled between the antenna and the mixer of the first coexisting radio, wherein the first and second LNA inputs are coupled with an output of the RF filters.

21. The communication device as in claim 14, wherein substrates of the first FET, second FET, third FET and fourth FET are coupled to ground, and wherein the first FET, second FET, third FET and fourth FET are NMOS FETs.

22. The communication device as in claim 14, wherein the first coexisting radio is in close physical proximity to at least one of the other two or more coexisting radios.

23. A method for improving performance of a coexisting radio comprising:
integrating a notch filter in an LNA of a first coexisting radio of an apparatus comprising two or more coexisting radios;
coupling a signal from an antenna to LNA inputs of the LNA with the integrated notch filter; and
coupling a signal from LNA outputs of the LNA with the integrated notch filter to a mixer of the first coexisting radio.

24. The method as in claim 23, wherein the notch filter is a differential circuit.

25. The method as in claim 23, wherein the notch filter is a single-ended circuit that filters common mode signals.

26. The method as in claim 23, wherein the first coexisting radio has a carrier frequency that is in 2.4 GHz ISM frequency band and at least one of the other two or more coexisting radios has a carrier frequency that is in 1.9 GHz cellular band.

27. The method as in claim 23, wherein the notch filter is integrated into the first coexisting radio which receives signals at lower signal strengths compared to at least one of other two or more coexisting radios.

28. The method as in claim 23, further comprising designing the notch filter with a combination of capacitors, inductors and/or transformers.
